(19) United States
(12) Patent Application Publication
(10) Pub. No.: US 2013/0254129 A1
(43) Pub. Date: Sep. 26, 2013

(54) TECHNOLOGICAL SOLUTION TO INTERVIEW INEFFICIENCY

(71) Applicants: Martin Perlmutter, Tiburon, CA (US); Basit Hussain, Odessa, FL (US); Marvin Scaff, Tampa, FL (US); Jody Haneke, Tampa, FL (US)

(72) Inventors: Martin Perlmutter, Tiburon, CA (US); Basit Hussain, Odessa, FL (US); Marvin Scaff, Tampa, FL (US); Jody Haneke, Tampa, FL (US)

(21) Appl. No.: 12/681,776

(22) PCT Filed: Oct. 6, 2008
(86) PCT No.: PCT/US08/11539

§ 371 Date: Nov. 2, 2010

Related U.S. Application Data
(60) Provisional application No. 60/978,095, filed on Oct. 5, 2007.
(60) Provisional application No. 60/978,092, filed on Oct. 5, 2007.

(51) Int. Cl. G06Q 10/10

(52) U.S. Cl. CPC G06Q 10/1053
USPC 705/321

(57) ABSTRACT

A technique for job screening may involve providing a video-augmented resume. An aspect of the technique can include providing a teaser video builder to resume-building users to enforce rules regarding “teaser” video entry. Alternatively or in addition, video could be augmented to push data that would normally be acquired in interview forward in a hiring process. Another aspect of the technique can include providing a cue point editor that augments video with hyperlinks and special effects. A similar editor can be provided to reviewers that are available, for example, in a social network for resume-building users.

### PRIORITY CLAIM

This application claims priority to U.S. Provisional Patent Applications 60/978,092 and 60/978,095, both filed 5 Oct. 2007, which are incorporated herein by reference.

### BACKGROUND

Technological advancement has improved matching jobs to job seekers, primarily because job listings can be made readily available to potential employees, and resumes can be made readily available to potential employers. Once the employer has the resume, an interview typically follows, particularly when great care is taken by employers in hiring the best possible employee for a job.

Perhaps in part because interviewing job applicants is so familiar and time-tested, it has become accepted as a desirable part of the hiring process, and relatively little innovation has pushed data that might be acquired in an interview forward in the hiring process. Nevertheless, it would be advantageous to develop a process that streamlines the hiring process with a technological solution to push more data into the front-end of the hiring process, thereby limiting the need for as many follow-up interviews.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique for job screening may involve providing a video-augmented resume. However, a full video could be considered burdensome. So an aspect of the technique can include providing a teaser video builder to resume-building users to enforce rules regarding “teaser” video entry. Alternatively or in addition, video could be augmented to push data that would normally be acquired in interview forward in a hiring process. Another aspect of the technique can include providing a cue point editor that augments video with hyperlinks and special effects. A similar editor can be provided to reviewers that are available, for example, in a social network for resume-building users.

Advantageously, from the perspective of employers, a video-augmented resume can push “interview data” forward in the hiring process. The resumes can be viewed confidentially without the knowledge of applicants, if desired, and equal treatment can be ensured even as is eliminated the need for a face-to-face interview when a hiring professional knows in advance that there is no interest based on the interview data.

### BRIEF DESCRIPTION OF THE DRAWINGS

The following figures are intended to illustrate, by way of example but not limitation, aspects of techniques described in this paper.

FIG. 1 depicts an example of an object-oriented (OO) job seeker/hiring professional system.

FIG. 2 depicts an example of a resume server.

FIG. 3 depicts an example of a teleprompter engine.

FIG. 4 depicts a flowchart of a method for providing a video-augmented resume.

FIG. 5 depicts an example of a job server.

FIG. 6 depicts an example of a computer system.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

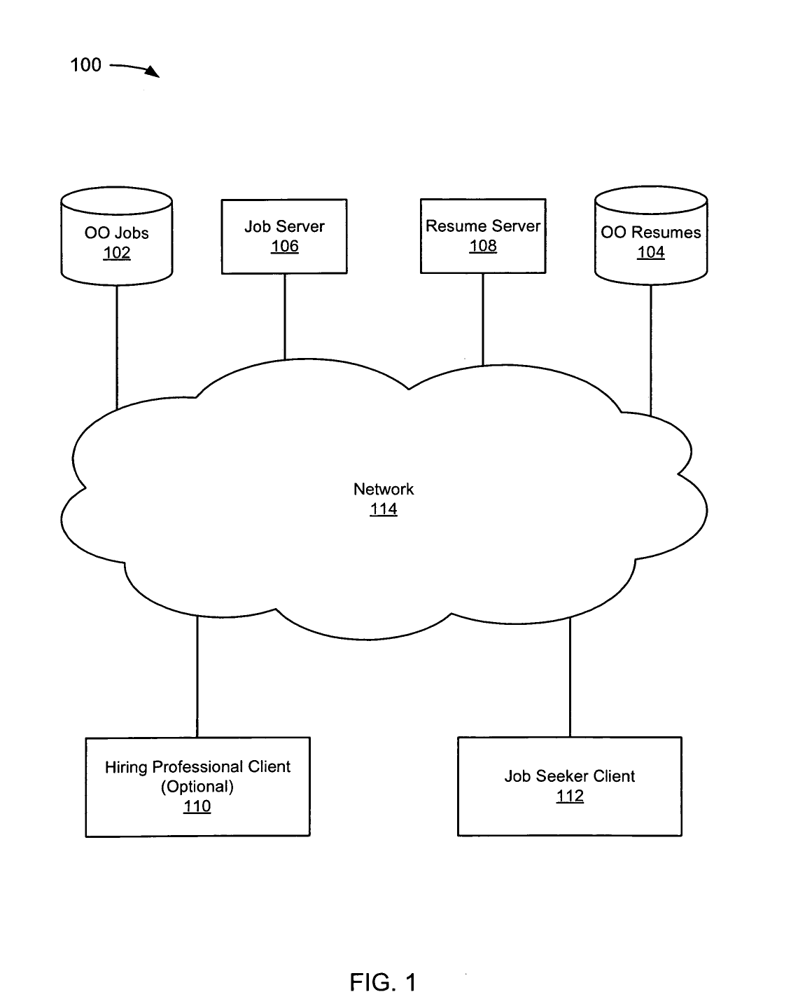

FIG. 1 depicts an example of an object-oriented (OO) job seeker/hiring professional system 100. The system 100 includes an OO jobs database 102, an OO resumes database 104, a job server 106, a resume server 108, a hiring professional client 110, a job seeker client 112, and a network 114 coupling the OO jobs database 102, the job server 104, the resume server 106, the OO resumes database 108, the hiring professional device 110, and the job seeker device 112.

In the example of FIG. 1, the OO jobs database 102 can be implemented as hardware and/or software implemented in hardware. As used in this paper, a database can include a traditional database, a table, an array, or any other applicable data structure capable of storing data in a manner that is at least somewhat convenient to a user of the database. A database can optionally include a database interface that can be implemented in whole or in part on the hardware device on which data of the database is stored, or in whole or in part on a device that is accessing the data. As used in this paper, a database can be a centralized repository (e.g., a device that stores all of the data of the database) or a distributed repository (e.g., multiple devices, each storing a portion of the database). Data can be stored in any applicable memory, including non-volatile storage, volatile storage (e.g., random access memory (RAM)), cache, or registers. Reading and writing data requires a processor, though any applicable known or convenient processor technology can be used. A special-purpose database processor can include a processor with relevant instructions, whether stored in hardware or in software implemented in hardware, to read and write data in a manner that is appropriate to the techniques described in this paper.

The OO jobs database 102 includes entries, such as database records, table elements, array elements, or any other applicable elements that can be stored in an OO fashion in the jobs database 102. It can be advantageous to break down a job into sub-entries, such as fields, or any other applicable elements. In a typical OO implementation, sub-entries are objects that can, for example, be nested (entries, if implemented as objects, can also be nested). If at least some of the data is stored in a similar fashion (e.g., as HR-XML elements), integration is easy with other systems using similar data, errors (such as input and translation errors) can be reduced, targeted searches within the system 100 and/or across other systems are possible, etc. The OO data is advantageous when making use of tools described in this paper.

Sub-entries that may be found in a job object might include, for example, job title, salary, location, and skill requirements.

In the example of FIG. 1, the OO resumes database 104 can be implemented as hardware and/or software implemented in hardware. The OO resumes database 104 includes entries, such as database records, table elements, array elements, or any other applicable elements that can be stored in an OO fashion in the resumes database 104. Advantageously, the fields of the OO jobs database 102 entries and the fields of the OO resumes database 104 entries can be matched in a targeted fashion, making resumes more useful to those who post jobs and/or job listings more useful to those who seek jobs.

The OO resumes database 104 and the OO jobs database 102 are coupled to one another through the network 114. The coupling could be through a local area network (LAN) or some other sub-network of a larger network. Alternatively, the OO resumes database 104 and the OO jobs database 102 could be implemented, in whole or in part, on the same computing device.

Advantageously, the OO format of the resume entries in the OO resumes database 104 facilitates the use of interesting integrated technologies. For example, a resume entry can include a video object that is integrated with other fields of the resume entry. The video object creation and use is described later with reference to the other FIGS. In addition, since the technologies are integrated, the OO jobs database 102 can, depending upon the implementation and/or configuration, search on the integrated technologies.

Sub-entries that may be found in a resume object might include, for example, qualifications, education, and experience. Other sub-entries could be the same as those of job objects to facilitate matching.

In the example of FIG. 1, the job server 106 can be implemented as hardware and/or software implemented in hardware. As used in this paper, a server can refer to a process running on a computing device, or to the computing device itself. In the latter case, the computing device can have multiple distinct server processes running simultaneously, but it should be clear from context which server process is being discussed at a given time. To be useful, a server is coupled to a client such that communication is facilitated between the server and the client. As used in this paper, the term server may or may not refer to a web server. A web server is configured to operate with the protocols of the World Wide Web. Optionally, a web server can be part of an Internet Service Provider (ISP) system that provides access to the Internet for client systems.

The job server 106 and the OO jobs database 102 are coupled to one another through the network 114. The coupling could be through a local area network (LAN) or some other sub-network of a larger network. Alternatively, the job server 106 and the OO jobs database 102 could be implemented, in whole or in part, on the same computing device.

In the example of FIG. 1, the resume server 108 can be implemented as hardware and/or software implemented in hardware. The resume server 108 and the OO resumes database 104 are coupled to one another through the network 114. The coupling could be through a local area network (LAN) or some other sub-network of a larger network. Alternatively, the resume server 108 and the OO resume database 104 could be implemented, in whole or in part, on the same computing device.

The resume server 108 and the job server 106 are coupled to one another through the network 114. The coupling could be through a local area network (LAN) or some other sub-network of a larger network. Alternatively, the resume server 108 and the job server 106 could be implemented, in whole or in part, on the same computing device.

In the example of FIG. 1, the hiring professional client 110 can be implemented as hardware and/or software implemented in hardware. As used in this paper, a client can refer to a process running on a computing device, or to the computing device itself. In the latter case, the computing device can have multiple distinct client processes running simultaneously, but it should be clear from context which client process is being discussed at a given time. To be useful, a client is coupled to a server such that communication is facilitated between the server and the client.

The hiring professional client 110 and the OO jobs database 102 are coupled to one another through the network 114. The coupling could be through a local area network (LAN) or some other sub-network of a larger network. Alternatively, the hiring professional client 110 and the OO jobs database 102 could be implemented, in whole or in part, on the same computing device.

The hiring professional client 110 and the OO resumes database 104 are coupled to one another through the network 114. The coupling could be through a local area network (LAN) or some other sub-network of a larger network. Alternatively, the hiring professional client 110 and the OO resumes database 104 could be implemented, in whole or in part, on the same computing device.

The hiring professional client 110 and the job server 106 are coupled to one another through the network 114. The coupling could be through a local area network (LAN) or some other sub-network of a larger network. Alternatively, the hiring professional client 110 and the job server 106 could be implemented, in whole or in part, on the same computing device.

The hiring professional client 110 and the resume server 108 are coupled to one another through the network 114. The coupling could be through a local area network (LAN) or some other sub-network of a larger network. Alternatively, the hiring professional client 110 and the resume server 108 could be implemented, in whole or in part, on the same computing device.

The hiring professional client 110 may or may not be necessary to access the OO jobs database 102. For example, an entity that wishes to post jobs may have direct access to a database interface to the OO jobs database 102, making the job server 106 unnecessary from the perspective of an entity that wishes to post jobs. However, in many implementations, the hiring professional client 110 will have the ability to establish a server-client relationship with the job server 106 to access the OO jobs database 102 for the purpose of uploading entries to the OO jobs database 102, editing entries in the OO jobs database 102, or removing entries from the OO jobs database 102. In implementations where multiple hiring professionals have access to the OO jobs database 102, it is likely that a first hiring professional acting as an agent for a first entity that wishes to post jobs will not have the ability to edit or remove entries associated with a second hiring professional acting as an agent for a second entity that wishes to post jobs.

The hiring professional client 110 may or may not be necessary to access the OO resumes database 104. For example, an entity that wishes to view resumes may have direct access to a database interface to the OO resumes database 104, making the resume server 108 unnecessary from the perspective of an entity that wishes to view resumes. However, in many implementations, the hiring professional client 110 will have the ability to establish a server-client relationship with the resume server 108 to access the OO resumes database 104 for the purpose of viewing resumes.

Since the OO jobs database 102 and the OO resumes database 104 could be implemented in such a way that the hiring professional client 110 is unnecessary, the hiring professional client 110 is indicated to be optional in the example of FIG. 1. A hiring professional, as used in this paper, is an agent that makes hiring decisions on behalf of an entity that wishes to hire a job seeker. Thus, a hiring professional (i.e., not necessarily a client) will be involved in any implementation of the system 100 where hiring decisions are made after matching a resume to a job listing.

In the example of FIG. 1, the job seeker client 112 can be implemented as hardware and/or software implemented in hardware. It is expected that the job seeker client 112 will need to establish a server-client relationship with the job server 106 in order to view entries of the OO jobs database 102. However, it is not necessary that the job seeker client 112 be able to access the OO jobs database 102. For example, the system 100 could be implemented (in whole or in part) such that job seekers are only able to post resumes, and hiring professionals make decisions regarding hiring without the job seekers learning about job listings.

It is expected that the job seeker client 112 will need to establish a server-client relationship with the resume server 108 in order to upload entries to the OO resumes database 104, edit entries in the OO resumes database 104, or remove entries from the OO resumes database 104. In implementations where multiple job seekers have access to the OO resumes database 104, it is likely that a first job seeker will not have the ability to edit or remove entries associated with a second job seeker.

The job seeker client 112 and other components of the system 100 are coupled to one another through the network 114. One or more of the couplings could be through a local area network (LAN) or some other sub-network of a larger network. Alternatively, the job seeker client 112 and one or more of the other components could be implemented, in whole or in part, on the same computing device. This alternative is seen as relatively unlikely unless there are implemented appropriate security controls to protect the integrity of the data.

In the example of FIG. 1, the network 114 can include the computing devices associated with the components of the system 100 and/or other computing devices coupled together though a known or convenient network, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Client computer systems can, with the appropriate web browsing software, view web pages provided by web servers. Access to the Internet allows users to exchange information, receive and send e-mails, and view documents, such as documents which have been prepared in HTML or XML format. These documents are often provided by servers, which are referred to as being “on” the Internet.

In the example of FIG. 1, in operation, the hiring professional client 110 contacts the job server 106 in an effort to establish a server-client relationship over the network 114. When the server-client relationship is established, the hiring professional client 110 sends a job object to the job server 106, and the job server 106 stores the job object as an entry in the OO jobs database 102. The job server 106 may or may not edit the job object prior to saving it as an entry. In general, the job will include nested objects (e.g., fields) so that the job server 106 can save the relevant values in the OO jobs database 102, and add additional values dynamically either when the job object is received (e.g., to add a field indicating the origin of the job object) or later (e.g., if the job object is updated) as appropriate.

In the example of FIG. 1, in operation, the job seeker client 112 contacts the resume server 108 in an effort to establish a server-client relationship over the network 114. When the server-client relationship is established, the job seeker client 112 sends a resume object to the resume server 108, and the resume server 108 stores the resume object as an entry in the OO resumes database 104. The resume server 108 may or may not edit the resume object prior to saving it as an entry. In general, the resume will include nested objects (e.g., fields) so that the resume server 108 can save the relevant values in the OO resumes database 104, and add additional values dynamically either when the resume object is received (e.g., to add a field indicating the origin of the resume object) or later (e.g., if the resume object is updated) as appropriate.

In the example of FIG. 1, in operation, a job seeker can provide a resume object with reference to a specific job entry. For example, the job seeker client 112 could contact the job server 106 in an effort to establish a server-client relationship over the network 114. (It should be noted that the job seeker client 112 could be considered a different client as when contacting the resume server 108, but for illustrative simplicity, all clients associated with the job seeker are referred to collectively as the job seeker client 112.) When the server-client relationship is established, the job seeker client 112 receives a jobs listing in accordance with search criteria. The search criteria can be default search criteria, implicit search criteria that takes into account known values associated with the job seeker, previously entered values (e.g., if the job seeker has an account with parameters or preferences), and/or dynamically entered search criteria. Since the jobs are stored in an OO fashion, the job seeker can ascertain which fields have required values, which fields have suggested values, whether there are custom fields, a job ID that can be used to flag the job seeker's resume in association with the job listing, or other relevant data that a hiring professional requires to weed out unqualified job seekers or that a job seeker can use to increase the likelihood of being noticed by a hiring professional. The job seeker can then implicitly provide a resume with reference to a specific job entry (e.g., by providing relevant field values) or explicitly with reference to the job ID or equivalent explicit flagging mechanism.

In the example of FIG. 1, in operation, a hiring professional can provide a job object with reference to a specific resume entry. For example, the hiring professional client 110 could contact the resume server 108 in an effort to establish a server-client relationship over the network 114. (It should be noted that the hiring professional client 110 could be considered a different client as when contacting the job server 106, but for illustrative simplicity, all clients associated with the hiring professional are referred to collectively as the hiring professional client 110.) When the server-client relationship is established, the hiring professional client 110 receives a resumes listing in accordance with search criteria. The hiring professional can then implicitly provide a job with reference to a specific resume entry (e.g., by providing relevant field values) or explicitly with reference to the resume ID or equivalent explicit flagging mechanism. It should be noted that the hiring professional may simply prefer to contact the relevant job seeker directly, since the job seeker is known. However, it may be seen as more efficient, given the fact that resumes sometimes grow stale, to see if the job seeker is still on the market by ensuring a match with the job seekers, while also posting the job object for other job seekers.

In the example of FIG. 1, in operation, after a job entry is in the OO jobs database 102 and a resume entry is in the OO resumes database 104, it is possible to match the job entry to the resume entry. Advantageously, since the entries are stored in OO form, specifically targeted matching is possible. For example, a job entry may have an “industry experience” field that must have a value greater than, e.g., 4 years. Or the job entry may have an “industry experience” field that should (but not must) have a value greater than, e.g., 4 years. Or industry experience may have no relevance for matching purposes.

If a match is found, the hiring professional can be informed of the match, the job seeker can be informed of the match, or both. Information can be pushed to the relevant party (e.g., by sending an email notice), or the information can pulled by the relevant party (e.g., by logging in).

When the hiring professional is to be informed, the resume server 108 provides the relevant resume objects, identifiers for the resume objects, or a notification that relevant resume objects are available (perhaps for a price, depending upon the business model implemented). It should be noted that the resume server 108 could, in this case, be an email server or some other server than that establishing a server-client relationship as described previously. For illustrative convenience, the resume server 108 is intended to include any server that provides resume-related data to the hiring professional and/or the job seeker.

When the job seeker is to be informed, the job server 106 provides the relevant job objects, identifiers for the job objects, or a notification that relevant resume objects are available. It should be noted that the job server 106 could, in this case, be an email server or some other server than that establishing a server-client relationship as described previously. For illustrative convenience, the job server 106 is intended to include any server that provides job-related data to the hiring professional and/or the job seeker.

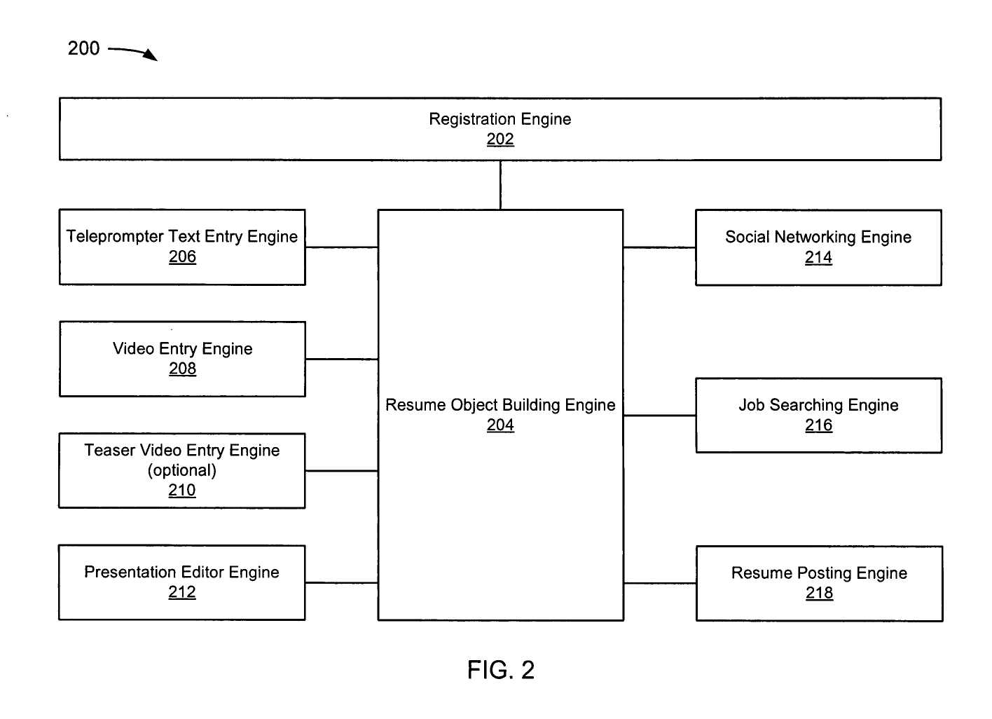

FIG. 2 depicts an example of a resume server system 200. The system 200 includes a registration engine 202, a resume object building engine 204, a teleprompter text entry engine 206, a video entry engine 208, a teaser video entry engine 210, a presentation editor engine 212, a social networking engine 214, a job searching engine 216, and a resume posting engine 218.

In the example of FIG. 2, the registration engine 202 can be implemented as hardware and/or as software implemented in hardware. As used in this paper, an engine is a combination of instructions and a processor configured to execute the instructions. Any applicable known or convenient processor technology can be used. A special-purpose engine processor can include a processor with relevant instructions to manipulate data in a manner that is appropriate to the techniques described in this paper. In a typical implementation, an engine will be associated with at least some instructions that are executed by the processor, though it is possible that the processor would be implicit in that the instructions are, for example, implemented in a solid-state device without a conventional processor or executables stored in memory. More likely, a processor is specially configured to carry out tasks associated with the relevant engine. Configuration of the processor can occur at the time of manufacture, later in the form of “read-only” instructions executable by the processor and/or dynamically in the form of software loaded into appropriate hardware registers for execution by the processor. A processor is frequently shared with instruction sets from various programs, some of which may not be related to the relevant engine, and instructions associated with the relevant engine, other than perhaps the most trivial, typically cannot be kept in hardware registers concurrently. Sometimes, due to the size of the instruction set and/or the memory load, instructions associated with the relevant engine cannot even be kept in cache or memory (e.g., RAM), and must instead be kept in non-volatile storage (e.g., a hard disk).

The registration engine 202 can facilitate access by a job seeker to functions of the system 200. The registration engine 202 may include security modules that, when executed, restrict access only to appropriate job seekers, registration modules that, when executed, enable a job seeker to enter and the system 200 to receive data associated with the job seeker, and account modules that, when executed, enable a job seeker to login and maintain an account associated with the system 200. The registration engine 202 may include a user database (not shown) with data that may include passwords, account names, group names, user data, user preferences, job search preferences, and the like.

In the example of FIG. 2, the resume object building engine 204 can facilitate building a resume object by a job seeker. The resume object fields are not stored as a flat text file; rather, they are stored as, for example, XML elements. The XML elements can follow the HR-XML schema put forward by the Organization for Advanced Structured Information Standards (OASIS) group. This facilitates indexing and targeted searches within correct resume object areas in order to provide hits that are more meaningful.

The resume object that a job seeker builds may include more data than a job seeker would wish to share in a particular resume. For example, a job seeker might want to enter personal information (e.g., marital status or sexual orientation) for the purpose of matching jobs, but never provide the personal information in a resume. Moreover, a job seeker may wish to prepare multiple resumes, each with a different set of fields. For example, a job seeker may not wish to list hobbies in a first resume, but may wish to list hobbies in a second resume. Where a distinction can be drawn, the resume object with every entry can be referred to as a comprehensive resume object, and a resume object that is actually provided as a resume can be referred to as a targeted resume object, though the distinction normally should be discernable from context.

In some implementations, the resume object building engine 204 can track application status, letting a job seeker know where in the resume building process they are currently. This can include estimated times to completion, for example.

In the example of FIG. 2, the teleprompter text entry engine 206 can receive text from a job seeker for use with the presentation editor engine 212 (described later). Teleprompter text can include text for a speech that a job seeker intends to use in preparing a video object. The teleprompter text can be functionally integrated with the presentation editor engine 212 such that the presentation editor engine 212 can import a text file and facilitate editing the text file by the job seeker using the presentation editor engine 212. Advantageously, the text can be hyperlinked to resume object fields, or to other locations, could be associated with special effects that are perhaps automatically added as cue point animations, and could be indexed to audio so that a search on the text file can be indexed to an audio location of a video presentation.

Keywords can be identified in text in advance (e.g., by “meta-tagging” the teleprompter text) or a moderator or advisor could add keywords to a list for capture by a text search. Assigning keywords to a point in a video can allow a searcher to hear what a job seeker has to say about a particular keyword. For example, if “Unix” is a keyword, a job seeker may say “I have been programming in Unix for 7 years.” A searcher could select the keyword Unix to hear the job seeker say that. These keywords may or may not have explicit resume object fields so keywords add a new dimension to a resume that makes use of the OO format. The portion of the video that is played after a keyword is found depends upon the implementation, but presumably would be at the indicated time (in the case of an explicit keyword assignment) or perhaps at the start of a sentence having the keyword. Advantageously, the start of a sentence can be easy to find in a video when the teleprompter text corresponds to the video.

In the example of FIG. 2, the video entry engine 208 can receive video input from a job seeker for use with the presentation editor engine 212 (described later). Video input can include a speech given by a job seeker, or other video data, such as a performance by the job seeker. The video input can be functionally integrated with the presentation editor engine 212 such that the presentation editor engine 212 can import a video file and facilitate editing or recording over the video file by the job seeker using the presentation editor engine 212. The video entry engine 208 should be able to convert video formats into relevant objects, depending upon implementation and/or preferences. For example, the video entry engine 208 may be able to convert AVI, MPEG, MOV, WMV or other known or convenient formats into a standardized format, such as the Flash format (and FLV file), that can be played from any browser.

Advantageously, a video entry engine 208 can be used in conjunction with the teleprompter text entry engine 210 to enable a speech+video+“bouncing ball” that follows the teleprompter text as the video progresses. Also, the scrolling teleprompter display is provided to help the job seeker speak professionally while looking directly at the camera. The teleprompter speed may be controllable to adjust to the job seeker's pace.

In the example of FIG. 2, the teaser video entry engine 210 can receive teaser video input from a job seeker for use with the presentation editor engine 212 (described later). Teaser video input must meet certain criteria that are defined by the system 200 regarding the length and content of the teaser video. For example, teaser videos are intended to be very short. The teaser video input can be functionally integrated with the presentation editor engine 212 such that the presentation editor engine 212 can import a teaser video and facilitate editing or recording over the teaser video by the job seeker using the presentation editor engine 212. The teaser video entry engine 210 may be considered optional because teaser video may or may not have the same format as video input and/or teaser videos may or may not be required.

In the example of FIG. 2, the presentation editor engine 212 can be used by a job seeker to create a resume object from various data components. The video file can be augmented with an editor that synchronizes video, text, and/or other elements in a presentation. This allows a job seeker to add presentation points to a video that appear, for example, next to the video as the video plays in order to accentuate the job seeker's speech. Job seekers can provide text messages in various sizes and fonts that enter at cue points and exit at end cue points as the video plays. This allows job seekers to deliver a message that will leave a lasting impression. Depending upon the implementation, the user can enter as many cue points as the duration of the video allows, and could combine and overlap animation. The result is, for example, an SWF file that plays the video in a first half of a playback window and the animation in the second half of a playback window.

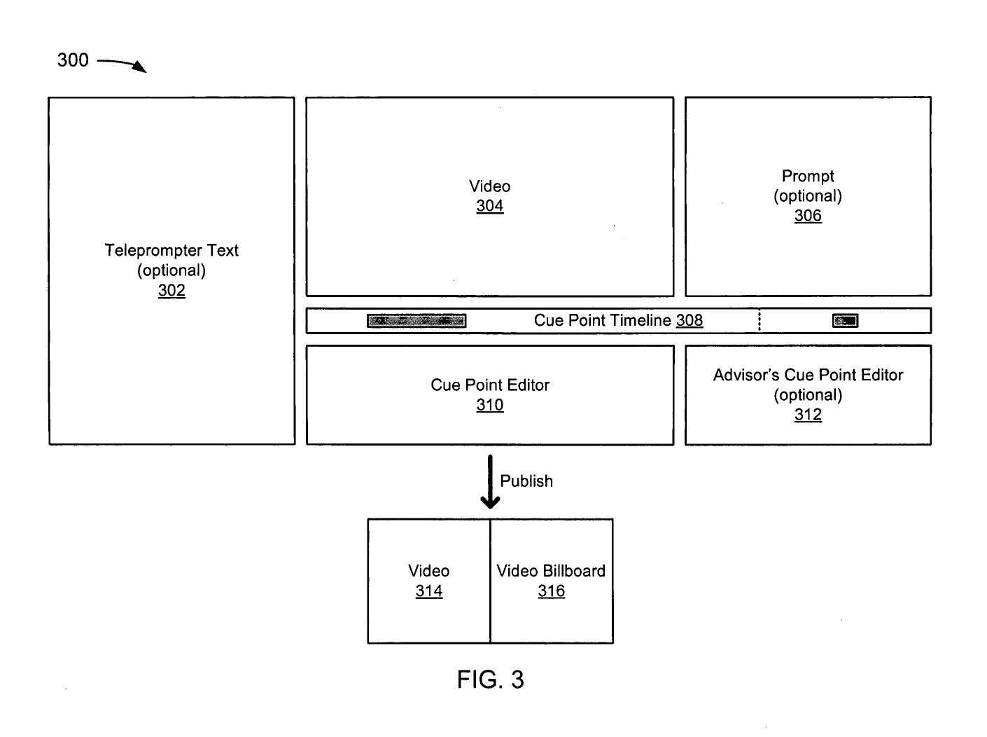

FIG. 3 depicts an example of a presentation editor conceptual diagram 300. The diagram 300 includes a teleprompter text pane 302, a video pane 304, a prompt pane 306, a cue point timeline bar 308, a cue point editor pane 310, an advisor's cue point editor pane 312, a video pane 314, and a video billboard pane 316. The panes of the diagram 300 need not be in any particular order, though some layouts may be more useful than others.

The teleprompter text pane 302 can display text provided in association with the teleprompter text entry engine 206 (FIG. 2). The teleprompter text pane 302 is optional because it is possible to enter a video and edit the video without a teleprompter, though a teleprompter is useful, particularly when looking at a camera near the teleprompter while recording a speech. If implemented appropriately, a job seeker can edit the text within the teleprompter text pane 302 on the fly.

Another use of the teleprompter text pane 302 is in association with voice recognition. If a job seeker is preparing a speech, a voice recognition engine (not shown) can translate the speech into text, which is displayed in the teleprompter text pane 302. If the job seeker notices errors in the text, the errors can be fixed with relative ease, thereby increasing the probability that a text search of the speech yields the relevant matches.

The video pane 304 can display a video provided in association with the video entry engine 208 (FIG. 2). The video can include a recording of a job seeker in real time (e.g., as a speech is recorded) or in playback (e.g., when viewing a prerecorded speech or other video clip). The video pane 304 can also display a teaser video provided in association with the teaser video entry engine 210 (FIG. 2). If implemented appropriately, a job seeker can perform typical actions in playing the video (e.g., play, pause, fast forward, etc.).

The prompt pane 306 can display prompts for a job seeker. For example, if the job seeker mentions a job that the job seeker held in Boston, Mass., when the job seeker mentions the job in the speech, the prompt may pane 306 may display “Do you want to mention that the job was in Boston?”The prompts can become particularly meaningful when speeches are prepared for particular job listings that have resume or video resume requirements. The prompt pane 306 can also display standardized suggestions, such as “Do you want to add animation?” or “Your teleprompter text is bigger than the suggested size of a five minute speech; so you might be speaking too fast.” If implemented appropriately, a job seeker can add prompts as reminders, e.g., “Add video file x here” or “Pause for emphasis.” The prompt pane 306 is optional because, while useful and perhaps novel, it is not necessary to prepare an adequate video presentation.

The cue point timeline bar 308 can graphically illustrate to a job seeker the current point in a speech (represented by a dashed line inside the cue point timeline bar 308) and cue points and end cue points within the speech (respectively represented by the start and end of shaded rectangles inside the cue point timeline bar 308). The current point in a speech can mean where a speaker is in real time, assuming a predetermined (e.g., arbitrary, recommended, or required) time duration, or where in a recording, assuming an actual recording duration. Alternatively, there could be a first indicator that indicates where a video is in relation to an actual recording length and a second indicator (not shown) that indicates where a video is in relation to a recommended or required recording length. If implemented appropriately, a job seeker can select and move cue points and end cue points to increase or decrease the duration of animation associated with the cue point, and select and move the current point indicator to move to a different point in the presentation.

The cue point editor 310 can depict the animation associated with a cue point when the current point indicator is between a cue point and an end cue point. The animation may be referred to as “video augmentation” because it is intended to provide a more compelling, useful, or interesting video presentation. If implemented appropriately, a job seeker can indicate whether the animation will appear “on top of” the video or “to the side” in a billboard.

The advisor's cue point editor pane 312 can depict suggested animation and advice from an advisor. The advisor need not be a formal advisor, and could simply be a peer or even perhaps a software agent. Alternatively, certain of an advisor's comments could appear in the prompt pane 306 or in an advisor's prompt pane (not shown). The advisor's cue point editor pane 312 is particularly useful because it can provide feedback at exactly the point in a presentation where the feedback is useful. Moreover, advisors might be able to provide animation, or edit animation previously entered by the job seeker, at just the point the advisor deems to be appropriate. Although this is useful and apparently novel, the advisor's cue point editor is optional because a job seeker does not need assistance to prepare an adequate presentation.

When a presentation is complete, a job seeker can publish the presentation. A completed presentation can appear in two panes when played, a video pane 314 and a video billboard pane 316. The video pane 314 can display the video (with animation that is intended to be on top of the video, if applicable) and the video billboard pane 316 can display animation between associated cue points and end cue points in the presentation.

Referring once again to the example of FIG. 2, the social networking engine 214 can enable a job seeker to find an advisor in a social network. This can be particularly useful to a job seeker who needs help crafting a compelling video-augmented resume. In some implementations, the social networking engine 214 can assign advisors based upon resume object fields and job seeker preferences. In some implantations, an advisor could simply happen upon a video augmented resume and provide advice sua sponte. If a completed presentation is provided to an advisor, or the advisor otherwise obtains the completed presentation, the advisor can, in some implementations, edit the presentation in a presentation editor that is similar to the diagram 300 (FIG. 3), and in a similar manner to that described with reference to FIG. 3.

Advantageously, input received via the social network need not always be provided to the job seeker. For example, a job seeker could request a confidential evaluation by a professor. Depending upon the implementation, the confidential evaluation may only be provided to bona fide hiring professionals and not to the job seeker. Bona fide hiring professionals can be defined by the system, and therefore their credentials can vary depending upon the implementation, job prerequisites, etc. A sua sponte advisor may wish to advise hiring professionals of good or bad qualities of a particular job seeker, as well, and have the recommendation (or lack thereof) kept similarly confidential without being anonymous, since anonymous recommendations can be considered of dubious value.

In the example of FIG. 2, the job searching engine 216 can enable a job seeker to look for jobs that meet search criteria associated with the job seeker. Since job objects are listed in OO fashion, just like resume objects, job seekers can easily search using fields from their own resume object. Advantageously, this enables job seekers to modify which fields of their resume object are used in a search to determine the best matches for jobs with great speed. Also, the job seeker can modify text entries to see which text is more effective at obtaining job matches (e.g., “web programmer” as compared to “web site designer”). And the job seeker can enter data that they have not yet attained to see how much of a difference it makes (e.g., a job seeker could enter “MSEE” in an education field to get a feel for whether it is worthwhile to obtain a Master's in electrical engineering prior to applying to schools).

Using relevant search criteria, a job seeker can use the job searching engine 216 to match fields exactly or, depending upon the implementation, preferentially. In some implementations, job seekers can rank fields in importance, and the job searching engine 216 can provide a listing of found jobs in a predicted order of preference. A job seeker can rank the jobs according to objective qualities (e.g., salary) or subjective qualities (e.g., by the “feel” a job posting gives the job seeker). A fairly simple implementation would enable a job seeker to rank the jobs explicitly, as well.

In some implementations, a job seeker can mark one or more job objects as “active” and have data show up in the resume building object 204 that is relevant to the active jobs. This can ensure that the job seeker enters all required or suggested fields or see if text entries are similar to a description associated with the active job objects. Where multiple jobs are active, the job seeker can toggle values to maximize the number of field matches for the job objects.

In some implementations, a job seeker can figure out what hiring professionals are looking for. For example, there may be a skill that a job seeker is missing in an otherwise complete resume. A job seeker may use the search results to decide to get a specific job prior to applying for the desired job, or to go back to school.

In the example of FIG. 2, the resume posting engine 218 can enable a job seeker to post a targeted resume object. An advisor may or may not be given access to a comprehensive resume object to help craft a more effective video-augmented resume, but when the resume is finally posted with the hopes of getting the attention of a hiring professional, the resume should be polished. In some implementations, advisors normally have access only to the resume objects that are published, while in other implementations the resume objects can be sent in confidence to the advisor, or posted in a subnetwork that is not yet open to hiring professionals.

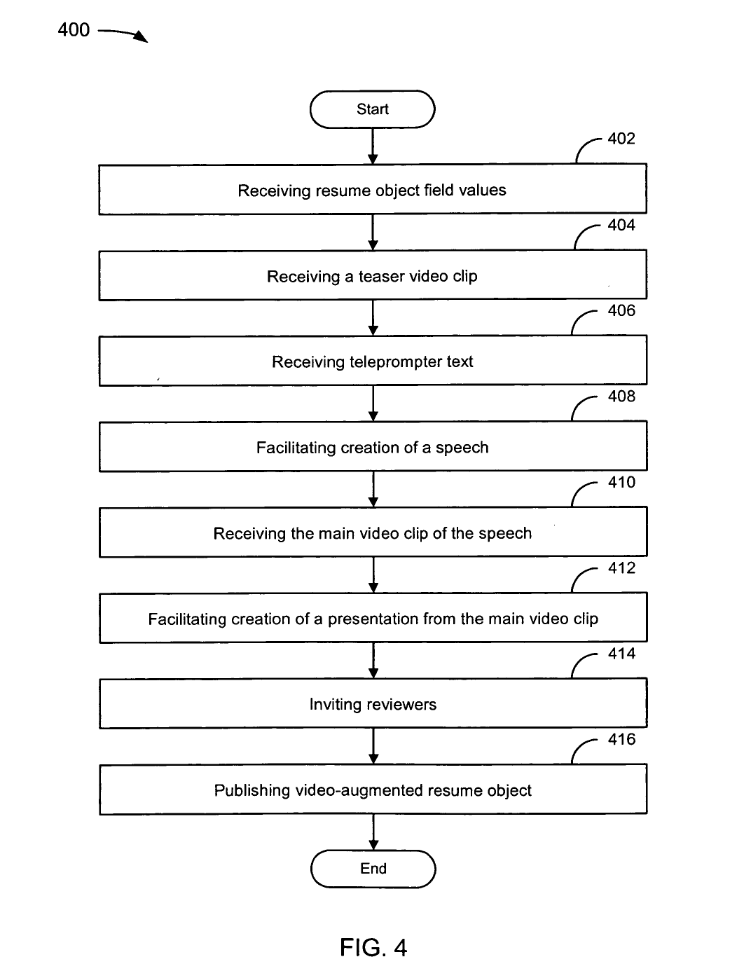

FIG. 4 depicts a flowchart 400 of a method for providing a video-augmented resume. The method is organized as a sequence of modules in the flowchart 400. However, it should be understood that these and modules associated with other processes and methods described herein may be reordered for parallel execution or into different sequences of modules. In the example of FIG. 4, a process is described that can be used by job seekers to enter a video-augmented resume online. The video-augmented resume will presumably have more impact and provide benefits to both the job seeker and the hiring professional who eventually reviews the video-augmented resume.

In the example of FIG. 4, the flowchart starts at module 402 with receiving resume object field values. A job seeker starts by providing values that are input into resume object fields, such as education and job experience. The job seeker can provide other distinguishing qualifications. Some job objects, which may be known to the user, can include additional fields for which the job seeker can provide values. A resume building engine can receive all of these entries and save them in a comprehensive resume object for the job seeker. It should be noted that not all values need to be provided by the job seeker. For example, a job seeker may request a recommendation that is supposed to be kept confidential. The resume building engine could receive the recommendation, and save the recommendation in association with the job seeker, but the job seeker would not necessarily be permitted access to the recommendation.

In the example of FIG. 4, the flowchart 400 continues to module 404 with receiving a teaser video clip. A teaser video can enable a hiring professional to do an initial “sniff test” to determine whether a job seeker passes a first interview hurdle. This type of information would normally be gleaned only from an interview, but in this case is provided more quickly in the hiring process, thereby saving time. Depending upon the implementation, the teaser video clip can be perhaps 5 to 10 seconds long. Hiring professionals may or may not be able to require a particular teaser video length that deviates from a standard length. The teaser video clip can include practically any data, but there may be required data (e.g., primary strength).

In the example of FIG. 4, the flowchart 400 continues to module 406 with receiving teleprompter text. The length of the teleprompter text depends upon the implementation, and perhaps on the speed at which a job seeker speaks. In some implementations, there are no teleprompter text requirements, though there may be requirements for videos created using the teleprompter text. Thus, there will probably be some reasonable guidelines available at the outset, such as maximum reasonable word count, etc.

In the example of FIG. 4, the flowchart 400 continues to module 408 with facilitating creation of a speech. The system can provide for use by a job seeker a teleprompter displaying the teleprompter text. In some implementations, the job seeker will have helpful tools, tutorials, and examples available from the system (e.g., online) for speech coaching purposes.

In the example of FIG. 4, the flowchart 400 continues to module 410 with receiving the main video clip of the speech. When the speech is completed, the main video clip can be provided in a composition page. In an implementation, the resulting video is a high quality 16:9 aspect ratio display with good sound, but the exact characteristics of the video are implementation-specific.

In the example of FIG. 4, the flowchart 400 continues to module 412 with facilitating the creation of a presentation from the main video clip. The job seeker can add textual accentuations and, depending upon the implementation, other animation, throughout the speech. To this end, the job seeker can add cue points at which animation starts and end cue points when the animation ends. The animation can be provided in a billboard pane near the presentation when it is viewed. So the presentation can be considered a split screen presentation. In an implementation, a first pane (e.g., the left pane) includes the main video clip and a second pane (e.g., the right pane) includes text or other animation that emphasizes the speech delivered in the main video clip. Alternatively or in addition, animation could be provided as an overlay on top of the video.

The presentation is longer than the teaser video clip, and a hiring professional can easily access the presentation if the teaser video clip draws their interest. It may be noted that receiving the teaser video clip (module 404) could actually be carried out in conjunction with module 412. The job seeker can also prepare a short headline for display next to the teaser video clip in a billboard pane in conjunction with module 412 (or the headline could be input earlier).

In the example of FIG. 4, the flowchart 400 continues to module 414 with inviting reviewers. The system can invite advisors, peers, or others to review the presentation. Depending upon the implementation, the job seeker may be able to invite reviewers through channels outside of the system. However, the system may provide useful social networking tools that easily facilitate inviting peers, teachers, and colleagues for private review. These reviews allow for constructive feedback to the job seeker, who can use the information to improve the presentation. Following user review, a job seeker may find it desirable to return to a previous module of the flowchart 400 and continue from there.

In the example of FIG. 4, the flowchart 400 continues to module 416 with publishing a video-augmented resume object. Optionally, additional reviewers could be invited by the system (not shown) after a video-augmented resume object is published. For example, if the system handles resumes for consideration by a university, it may be desirable to solicit recommendations by high school teachers confidentially. In any case, publication of the video-augmented resume object means that hiring professionals can match the resume using OO job listings and/or view the video-augmented resume.

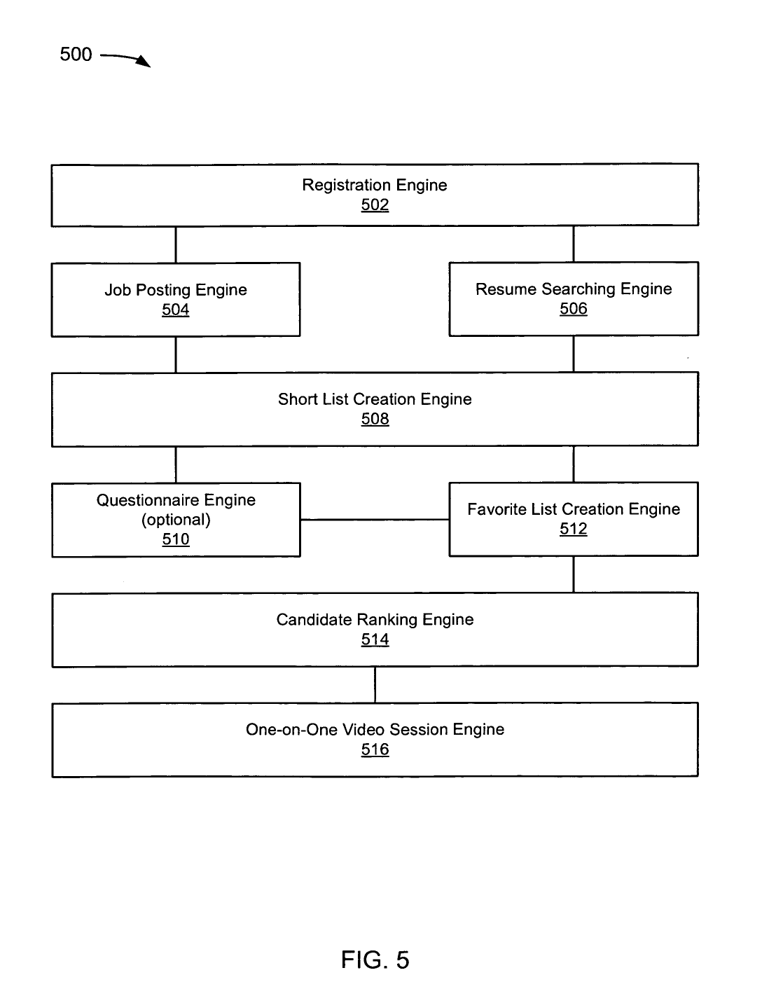

FIG. 5 depicts an example of a job server system 500. The system 500 includes a registration engine 502, a job posting engine 504, a resume searching engine 506, a short list creation engine 508, a questionnaire engine 510, a favorite list creation engine 512, a candidate ranking engine 514, and a one-on-one video session engine 516.

In the example of FIG. 5, the registration engine 502 can facilitate access by a hiring professional to functions of the system 500. The registration engine 502 may include security modules that, when executed, restrict access only to appropriate hiring professionals, registration modules that, when executed, enable a hiring professional to enter and the system 500 to receive data associated with the hiring professional, and account modules that, when executed, enable a hiring professional to login and maintain an account associated with the system 500. The registration engine 502 may include a user database (not shown) with data that may include passwords, account names, group names, user data, user preferences, resume search preferences, and the like.

In the example of FIG. 5, the job posting engine 504 is coupled to the registration engine 502. The job posting engine 504 can facilitate job object entry, posting, modification, and deletion. Job object fields can include required fields, required field values (or prohibited field values), suggested fields, suggested field values, fields of interest, or other fields useful for finding an appropriate job seeker's resume object.

In the example of FIG. 5, the resume searching engine 506 is coupled to the registration engine 502. Instead of (or in addition to) receiving job postings through the job posting engine 504, the resume searching engine 506 can conduct a search on resume objects using search criteria. The search criteria can be implicit based upon data associated with the hiring professional or explicit (whether entered in advance as a preference, or entered dynamically at the time of search). Hiring professionals may find it convenient to toggle required field values to see how the pool of candidates grows or shrinks. Depending upon the law and implementation, it may be desirable to conduct searches on fields that identify members of protected groups.

In the example of FIG. 5, the short list creation engine 508 is coupled to the job posting engine 504 and the resume searching engine 506. The short list creation engine 508 can create a short list from resumes that match a job object that was posted previously, or from resumes received in a search. The short list can be created in accordance with preferences and field values. For example, resumes with preferred field values can be listed higher than those without. Some hiring professionals may wish to create minimum-length short lists such that resumes that do not even have “required” field values show up on the short list (presumably toward the end).

The short list creation engine 508 enables a hiring professional to use objective criteria to rank candidates. The objective criteria can use as wide or as narrow a brush as is desired to obtain a sufficient-sized sample of resume objects. A narrow brush may require exact matches or required values in fields, while a broad brush might have more preferred, but not required, field values.

In the example of FIG. 5, the questionnaire engine 510 is coupled to the short list creation engine 508. The questionnaire engine 510 can enable a hiring professional to gauge current interest in a job seeker by pinging them for some follow-up answers, to fill in some required fields that were perhaps unintentionally left blank, or perhaps to make up for a job object entry that was incomplete (e.g., dynamic field addition). The questionnaire engine 510 is optional.

In the example of FIG. 5, the favorite list creation engine 512 is coupled to the short list creation engine 508 and the questionnaire engine 510. Following receipt of answers to a questionnaire (if applicable) and/or viewing of a teaser video, a hiring professional can mark certain resumes as favorites. Those that are not marked as favorites may or may not be saved for later use. The teaser video enables a hiring professional to use data that would normally be unavailable until moving to an interview. Thus, the favorites list can be compiled more efficiently than before.

Advantageously, the favorite list creation engine 512 can weed out poor candidates using objective (e.g., answers to the questionnaire) or subjective (e.g., opinion of the teaser video) criteria with relative speed. The favorite list creation engine 512 can provide knowledge of a candidate's objective ranking (e.g., from the short list creation engine 508) or without such knowledge, enabling a hiring professional to judge subjective criteria without accidental bias from knowledge that one candidate has superior objective credentials, which may or may not be of determinative value in determining an ideal candidate.

When using a teaser video, there is no requirement that the hiring professional necessarily use a heading provided by a job seeker in association with the teaser video, and additional panes could be displayed when viewing the teaser video. For example, depending upon the implementation, the hiring professional may be looking for a person who scored well on the GRE, and wish to display the score a candidate received in a display pane during the playing of the teaser video. Or the hiring professional could search for desired text in the teleprompter text of a presentation and play an augmented teaser video with a few extra seconds of material from the presentation.

In the example of FIG. 5, the candidate ranking engine 514 is coupled to the favorite list creation engine 512. The candidate ranking engine 514 facilitates entry of explicit rankings of job seekers using all available criteria. The hiring professional can use both objective and subjective criteria in ranking the job seeker candidates. Also, the hiring professional has access to data that would normally only be available after a video interview. It is here where the hiring professional may decide to view a full presentation by a job seeker. Also, at this point in the process, the consideration of a particular candidate could have been kept confidential from all third parties and the candidates themselves, which can be advantageous in avoiding disparate impact claims for job seekers that voluntarily submit to this type of selection process.

In the example of FIG. 5, the one-on-one video session engine 516 is coupled to the candidate ranking engine 514. The one-on-one video session engine 516 can facilitate a video interview in short order following candidate ranking. A hiring professional could conceivably set up video session interviews for, for example, the day following candidate ranking.

A field of a resume object could include a calendar of open time slots, enabling a hiring professional to conceivably schedule a video session interview almost immediately. Such a field might enable scheduling of immediate time slots if open and the job seeker can be detected to be online (e.g., for chat) or responsive to text messaging or the like. The system might ignore a field that is too soon unless the job seeker can be located, even if the time slot is indicated to be open. For example, if a job seeker sets a field to “free all Friday” but the hiring professional is reviewing the job seeker's resume on Friday afternoon, the system may or may not ignore the indication that the job seeker is free at that time due to a lack of adequate notice (which could also be set by preferences).

In some implementations, a hiring professional can keep track of current job listings and job seeker consideration. For example, a progress bar for each job seeker that is being considered could show where in the process the job seeker is (e.g., on the short list, awaiting response, on the favored list, ranked, scheduled for video session interview, scheduled for in-person interview, offer made, offer accepted, and the like).

In some implementations, a hiring professional can obtain reports associated with particular job objects. For example, each job object could have associated values for status of the job seekers (e.g., % dropped, % contacted, % follow-up needed, etc.). Reports can also be associated with past job objects, providing statistics regarding the number of candidates who drop off at certain points within the hiring process, how frequently candidates are no longer available when considered, statistics on skill sets hired, such as how quickly certain skill sets can be picked up, statistics on skill sets that were not hired, such as how slowly certain skill sets were pursued unsuccessfully.

Generalized reports across industries can also be useful, and can be generated without disclosing confidential information. For example, skill sets hired compared to salaries paid for the skill sets might be useful data, and could be provided so long as the data is not traceable to a particular individual. Speed with which certain skill sets are hired, how many requisitions, how many placements, etc.

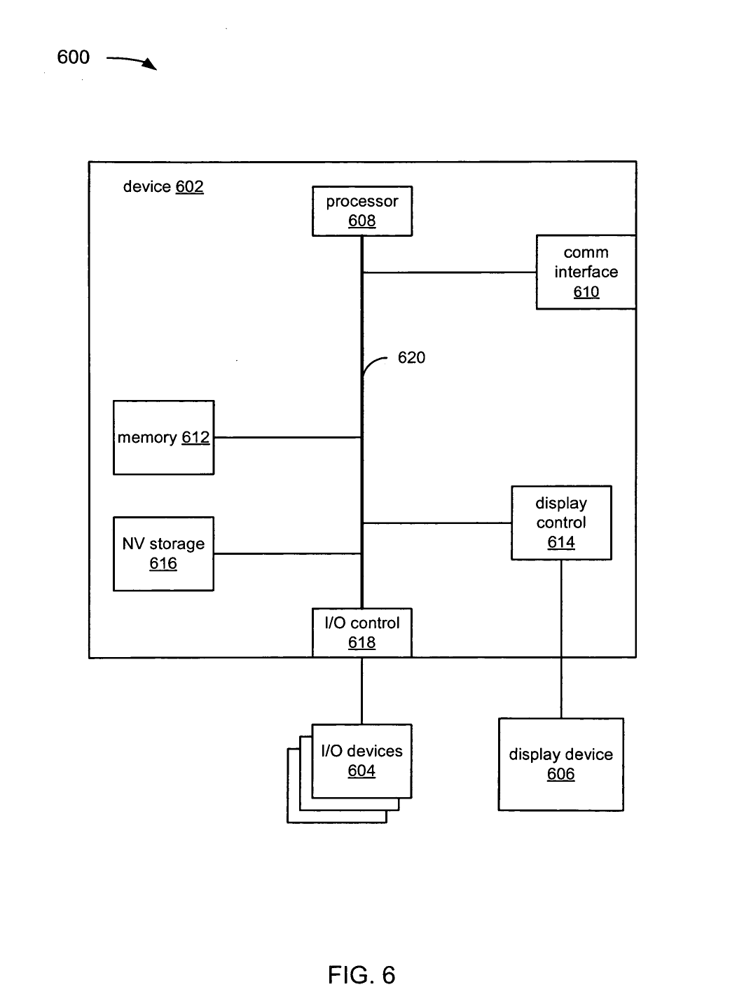

FIG. 6 depicts an example of a computing system that is representative of the computing systems discussed herein. The system 600 includes a device 602, I/O devices 604, and a display device 606. The device 602 includes a processor 608, a communications interface 610, memory 612, a display controller 614, non-volatile storage 616, and an I/O controller 618. The device 602 can be coupled to or include the I/O devices 604 and the display device 606. The processor 608 may be, for example, a conventional microprocessor such as an Intel Pentium microprocessor or Motorola power PC microprocessor. A bus 620 couples the processor 608 to the communications interface 610, the memory 612, the display controller 614, the non-volatile storage 616, and the I/O controller 618.

The device 602 interfaces to external systems through the communications interface 610, which may include a modem or network interface. It will be appreciated that the communications interface 610 can be considered to be part of the system 600 or a part of the device 602. The communications interface 610 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other some other known or convenient interface for coupling a computer system to other computer systems.

The memory 612 can be Dynamic Random Access Memory (DRAM) and can also include Static RAM (SRAM). The display controller 614 and the I/O controller 618 can be implemented with applicable known or convenient technology. The display controller 614 can control a display on the display device 606, which can be, for example, a cathode ray tube (CRT) or liquid crystal display (LCD). The I/O controller 618 can control the I/O devices 604, which can include a keyboard, disk drives, printers, a scanner, and other input and output devices, including a mouse or other pointing device.

The non-volatile storage 616 is often a magnetic hard disk, flash memory, an optical disk, or another form of storage for large amounts of data. Some of this data is often written, by a direct memory access process, into memory 612 during execution of software in the device 602. One of skill in the art will immediately recognize that the terms “machine-readable medium” or “computer-readable medium” includes any type of storage device that is accessible by the processor 608.

The system 600 is one example of many possible computer systems which have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 612 for execution by the processor 608. A Web TV system, which is known in the art, is also considered to be a computer system, but it may lack some of the features shown in FIG. 6, such as certain input or output devices. A typical computer system will usually include at least a processor, memory, and a bus coupling the memory to the processor.

In addition, the system 600 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 816 and causes the processor 608 to execute the various acts required by the operating system to input and output data and to store data in memory, including storing files on the non-volatile storage 616.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a resume server, coupled to an object-oriented (OO) resumes database, including:
a resume object building engine;
a presentation editor engine coupled to the resume object building engine;
a resume posing engine coupled to the resume object building engine;
wherein, in operation:
the resume object building engine populates sub-entries of a comprehensive resume object using job seeker data associated with a job seeker;
the presentation editor engine receives a video clip associated with the job seeker and associates video-augmentation data with cue points within the video clip, wherein the video clip and the video-augmentation data together form an augmented video, which is used to populate as a sub-entry the comprehensive resume object;
the resume posting engine provides a video-augmented resume object that includes at least the augmented video for storage in an OO resumes database.

2. The system of claim 1, further comprising the OO resumes database coupled to the resume server.

3. The system of claim 1, further comprising:
a teleprompter text entry engine coupled to the resume object building engine;
a video entry engine coupled to the resume object building engine;
wherein, in operation:
the teleprompter text entry engine receives teleprompter text associated with the job seeker;
the video entry engine facilitates creation of a speech, wherein the video clip received by the presentation editor engine is a video clip of the speech.

4. The system of claim 1, further comprising a teaser video entry engine, wherein, in operation, the teaser video entry engine facilitates the creation of a teaser video having a length of less than 10 seconds.

5. The system of claim 1, further comprising a social networking engine, wherein, in operation, the social networking engine invites reviewers to view the video-augmented resume object and provide feedback.

6. The system of claim 1, further comprising a job searching engine coupled to an OO jobs database, wherein, in operation:
the job searching engine provides search criteria useful in querying the OO jobs database, wherein at least one of the search criteria is associated with a sub-entry of the comprehensive resume object;
the job searching engine receives a job object associated with the search criteria;
the job searching engine makes the job object available to the job seeker.

7. The system of claim 1, further comprising a registration engine, wherein, in operation, the registration engine facilitates access by the job seeker to the resume object building engine.

8. The system of claim 1, further comprising:
a job server coupled to the OO resumes database;
an OO jobs database coupled to the job server;
wherein, in operation:
the job server matches an entry in the OO resumes database to an entry in the OO jobs database;
the job server makes the video-augmented resume object available to a hiring professional.

9. The system of claim 1, wherein, in operation, the presentation editor engine displays:
a video pane in which the video clip is played;
a cue point timeline bar on which cue points, end cue points, and progress through the video clip are displayed;
a cue point editor pane in which animation associated with a cue point and an end cue point is displayed.

10. The system of claim 9, wherein, in operation, the presentation editor engine displays a teleprompter text pane in association with the video clip played in the video pane.

11. The system of claim 9, wherein, in operation, the presentation editor engine displays a prompt pane in association with the video clip played in the video pane.

12. The system of claim 9, wherein, in operation, the presentation editor engine displays an advisor's cue point editor pane in association with the cue point editor pane.

13. A system comprising:
a job server, coupled to an object-oriented (OO) jobs database, including:
a short list creation engine;
a favorite list creation engine coupled to the short list creation engine;
a candidate ranking engine coupled to the favorite list creation engine;
wherein, in operation:
the short list creation engine matches objective criteria associated with a job object in the OO jobs database with a plurality of resume objects associated with a respective plurality of job seekers;
the favorite list creation engine makes a teaser video available to a hiring professional associated with the job object;
the favorite list creation engine receives subjective criteria from the hiring professional in association with at least a sub-plurality of the resume objects;
the candidate ranking engine facilitates ranking of the at least the sub-plurality of the resume objects in accordance with objective criteria associated with the job object and subjective criteria associated with the teaser video.

14. The system of claim 13, further comprising the OO jobs database.

15. The system of claim 13, further comprising a job posting engine, wherein, in operation:
the job posting engine receives data associated with the job object;
the job posting engine provides the job object for storage in the OO jobs database.

16. The system of claim 13, further comprising:
an OO resume database in which the plurality of resume objects are stored;
a resume searching engine coupled to the OO resume database, wherein, in operation, the resume searching engine provides the objective criteria associated with the job object as search criteria for use in querying the OO resume database.

17. The system of claim 13, further comprising a questionnaire engine, coupled to the short list creation engine and the favorite list creation engine, wherein, in operation:
the questionnaire engine receives at least one question associated with the hiring professional;
the questionnaire engine makes the question available to a job seeker associated with one of the at least the sub-plurality of resume objects;
the questionnaire engine receives an answer to the question;
the questionnaire engine makes the answer to the question available to the hiring professional.

18. The system of claim 13, further comprising a one-on-one video session engine, wherein, in operation:
the one-on-one video session engine receives an instruction associated with the hiring professional to invite to a video interview a job seeker associated with one of the at least the sub-plurality of resume objects;
the one-on-one video session engine makes the invitation available to the job seeker;
the one-on-one video session engine receives a response to the invitation from the job seeker;
the one-on-one video session engine schedules an interview between the job seeker and the hiring professional.

19. The system of claim 13, further comprising a registration engine, wherein, in operation, the registration engine facilitates access by the hiring professional to the short list creation engine.

20. A method comprising:
receiving resume object field values;
receiving a teaser video clip;
receiving teleprompter text;
facilitating creation of a speech;
receiving a main video clip of the speech;
facilitating creation of a presentation from the main video clip;
inviting reviewers;
publishing a video-augmented resume object.
